(19) United States
(12) Patent Application Publication
(10) Pub. No.: US 2025/0112292 A1
(43) Pub. Date: Apr. 3, 2025

(54) BATTERY MODULE

(71) Applicant: TOYOTA JIDOSHA KABUSHIKI KAISHA, Toyota-shi (JP)

(72) Inventors: Kazuhito Kato, Toyota-shi (JP); Atsushi Yamanaka, Nagoya-shi (JP); Shintaro Utsumi, Susono-shi (JP); Masato Ono, Nagoya-shi (JP); Yusuke Kintsu, Miyoshi-shi (JP); Takaaki Goto, Seto-shi (JP); Hiroki Awano, Susono-shi (JP)

(73) Assignee: TOYOTA JIDOSHA KABUSHIKI KAISHA, Toyota-shi (JP)

(21) Appl. No.: 18/641,781

(22) Filed: Apr. 22, 2024

(30) Foreign Application Priority Data
Sep. 29, 2023 (JP) 2023-169552

(51) Int. Cl. H01M 10/6551; H01M 10/613; H01M 10/625

(52) U.S. Cl. CPC H01M 10/6551; H01M 10/613; H01M 10/625; H01M 2220/20

(57) ABSTRACT

A battery module includes: a plurality of battery cells each including a metal layer and a heat seal layer, the plurality of battery cells having a laminate film in which an electrode body is accommodated and a heat seal layer in a peripheral edge portion is joined; a case in which the battery cells are accommodated in a state of being laminated in a thickness direction; and a heat conductive member provided on an inner wall of the case so as to be in contact with the metal layer exposed from the peripheral edge portion and configured to dissipate heat from the battery cells.

### CROSS-REFERENCE TO RELATED APPLICATION

This application claims priority to Japanese Patent Application No. 2023-169552 filed on Sep. 29, 2023, incorporated herein by reference in its entirety.

### BACKGROUND

### 1. Technical Field

The present disclosure relates to a battery module.

### 2. Description of Related Art

A battery module constructed in a structure in which a battery cell promotes heat dissipation by heat conduction through at least part of a sealed portion of a battery case where an electrode terminal is not disposed is known in the art (see, for example, Japanese Unexamined Patent Application Publication (Translation of PCT Application) No. 2011-504286 (JP 2011-504286 A)).

### SUMMARY

When the heat conductive member is a dedicated member separate from the member constituting the battery cell, however, the heat conduction path when the heat inside the battery cell is released to the outside is discontinuous inside the battery cell. The heat dissipation from the inside to the outside of the battery cell may be insufficient.

Therefore, an object of the present disclosure is to provide a battery module in which heat dissipation from the inside to the outside of a battery cell can be secured sufficiently.

In order to achieve the above object, a battery module according to an aspect of the present disclosure includes:
a plurality of battery cells each including a laminate film including a metal layer and a heat seal layer, housing an electrode body, and obtained by joining portions of the heat seal layer at a peripheral edge;
a case in which the battery cells are housed while being stacked in a thickness direction; and
a heat conductive member provided on an inner wall of the case in contact with the metal layer exposed from the peripheral edge and configured to dissipate heat from the battery cell.

According to the aspect of the present disclosure, the battery cells each include the laminate film including the metal layer and the heat seal layer. The laminate film houses the electrode body, and portions of the heat seal layer at the peripheral edge are joined. The battery cells are housed in the case while being stacked in the thickness direction, and the heat conductive member in contact with the metal layer exposed from the peripheral edge is provided on the inner wall of the case. Therefore, heat from the battery cell is dissipated.

That is, heat dissipation from the inside to the outside of the battery cell is secured sufficiently by the heat conductive member in direct contact with the metal layer of the laminate film.

In the battery module according to the aspect of the present disclosure, the inner wall of the case may include a plurality of recesses each configured to house the peripheral edge and the heat conductive member, and the metal layer exposed from the peripheral edge may be in contact with the heat conductive member inside the recess.

According to the aspect of the present disclosure, the inner wall of the case includes the recesses each configured to house the peripheral edge and the heat conductive member. The metal layer exposed from the peripheral edge is in contact with the heat conductive member inside the recess. Therefore, each battery cell is fixed and the posture of each battery cell is stabilized.

In the battery module according to the aspect of the present disclosure, the peripheral edges of two of the battery cells that are adjacent to each other may be housed in each of the recesses.

According to the aspect of the present disclosure, the peripheral edges of two of the battery cells that are adjacent to each other are housed in each of the recesses. Therefore, the volume efficiency of each battery cell with respect to the case is increased as compared with a configuration in which the peripheral edges of the battery cells are housed one by one in each of the recesses.

In the battery module according to the aspect of the present disclosure, distal end surfaces of the peripheral edges housed in the recess may be positioned on the same plane.

According to the aspect of the present disclosure, the distal end surfaces of the peripheral edges housed in the recess are positioned on the same plane. That is, the lengths of the peripheral edges of the battery cells housed in the recess are equal to each other. Therefore, the volume efficiency of each battery cell with respect to the case is increased, and the posture of each battery cell is further stabilized.

In the battery module according to the aspect of the present disclosure, a thickness of the metal layer of the battery cell housed in the case may be larger near a center in a stacking direction than near both ends in the stacking direction.

According to the aspect of the present disclosure, the thickness of the metal layer of each battery cell housed in the case is larger near the center of each battery cell in the stacking direction than near both ends in the stacking direction. It is known that, in a stacked body in which a plurality of battery cells is stacked, the temperature tends to increase near the center in the stacking direction and the heat conductivity increases as the thickness of the metal layer increases. Therefore, heat dissipation from the inside to the outside of each battery cell is secured efficiently in the stacking direction.

As described above, according to the present disclosure, it is possible to sufficiently secure heat dissipation from the inside to the outside of the battery cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view illustrating a battery electric vehicle including a battery module according to the present embodiment;

FIG. 2 is a schematic perspective view showing a configuration of a battery module according to the present embodiment;

FIG. 3 is a schematic plan view showing the configuration of the battery module according to the present embodiment in a state where the upper lid is removed;

FIG. 4 is a schematic front view illustrating a configuration of a battery cell accommodated in the battery module according to the present embodiment when viewed from a thickness direction;

FIG. 5A is a schematic cross-sectional view of an internal structure of the battery module according to a first embodiment as viewed from a vehicle width direction;

FIG. 5B is a schematic cross-sectional view of an internal structure of a battery module according to a modification of a first embodiment as viewed from a vehicle width direction; and

FIG. 6 is a schematic cross-sectional view illustrating the internal structure of the battery module according to the second embodiment when viewed from the vehicle width direction.

### DETAILED DESCRIPTION OF EMBODIMENTS

Hereinafter, embodiments of the present disclosure will be described in detail with reference to the drawings. For convenience of explanation, an arrow UP shown in the drawings is defined as a vehicle upward direction, an arrow FR is defined as a vehicle forward direction, and an arrow LH is defined as a vehicle leftward direction. Therefore, in the following description, when the vertical, front-rear, and left-right directions are described without special mention, it is assumed that the vertical direction of the vehicle, the front-rear direction of the vehicle front-rear direction, and the left-right direction (vehicle width direction) of the vehicle are indicated. The left-right direction is synonymous with the vehicle width direction.

In addition, the sizes of the members in the drawings are conceptual, and the relative relationships of the sizes between the members are not limited thereto. In addition, in the present embodiment, a numerical range indicated by using “−” means a range including numerical values described before and after “−” as the minimum value and the maximum value, respectively. Further, in the numerical range described in the present embodiment in a stepwise manner, the upper limit value or the lower limit value described in a certain numerical range may be replaced with the upper limit value or the lower limit value of the numerical range described in another stepwise manner.

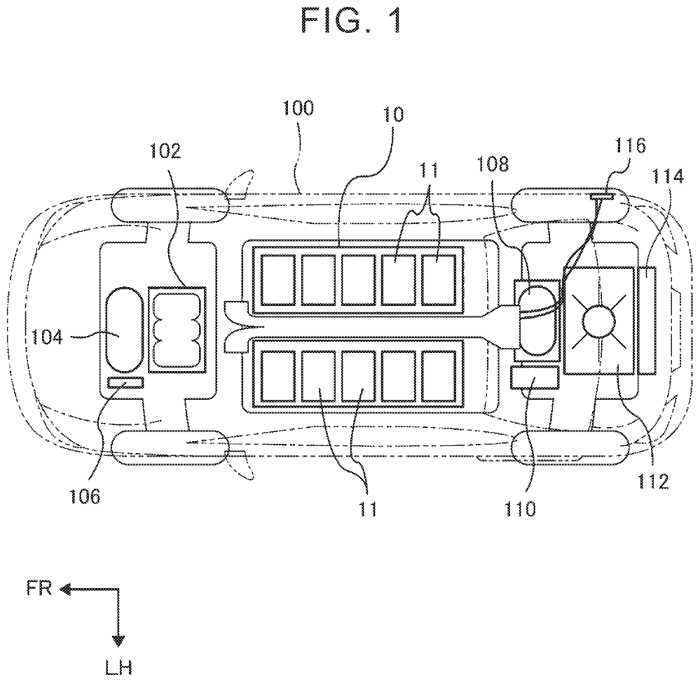

As illustrated in FIG. 1, the vehicle 100 according to the present embodiment is, for example, a battery electric vehicle (BEV in which the battery pack 10 is mounted under a floor. In the vehicle 100, DC/DC converters 102, the electric compressor 104, and PTC (Positive Temperature Coefficient) heaters 106 are arranged in front of the battery pack 10. Further, a motor 108, a gear box 110, an inverter 112, and a charger 114 are disposed on the rear side of the battery pack 10.

Therefore, the DC current outputted from the battery pack 10 is supplied to the electric compressor 104, PTC heaters 106, the inverter 112, and the like after the voltage is adjusted by DC/DC converters 102. Further, electric power is supplied to the motor 108 via the inverter 112, so that the rear wheels rotate and the vehicle 100 travels.

A charging port 116 is provided at a right side portion of the rear portion of the vehicle 100. Therefore, electric power is stored in the battery pack 10 via the charger 114 by connecting a charging plug of an external charging facility (not shown) to the charging port 116.

Note that the vehicle 100 shown in the figure is a rear wheel drive vehicle in which the motor 108 is mounted on the rear portion, but the present disclosure is not limited thereto, and may be a vehicle of a front wheel drive vehicle in which the motor 108 is mounted on the front portion. Further, the motor 108 may be a pair of vehicles mounted in front and rear directions, or may be a vehicle provided with an in-wheel motor on each wheel. That is, the arrangement and structure of the components constituting the vehicle 100 20 are not limited to the above-described configurations.

The battery pack 10 includes a plurality of battery modules 11. In the present embodiment, as an example, ten battery modules 11 are provided. Specifically, five battery modules 11 are arranged on the right side of the vehicle 100 with the thickness direction facing the front-rear direction, and five battery modules 11 are arranged on the left side of the vehicle 100 with the thickness direction facing the front-rear direction. The battery modules 11 are electrically connected to each other.

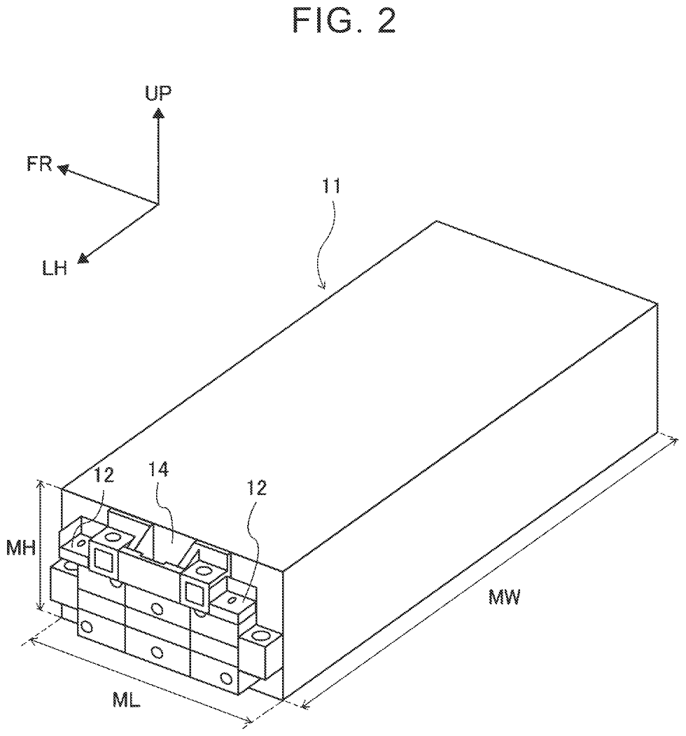

As shown in FIG. 2, the battery module 11 is formed in a substantially rectangular parallelepiped shape whose longitudinal direction is the vehicle width direction. The case 30 as the outer shell of the battery module 11 is made of an aluminum alloy. For example, the case 30 of the battery module 11 is formed by joining aluminum die-casting by laser welding or the like to both ends of an extruded material of an aluminum alloy.

A pair of voltage terminals 12 and a connector 14 are provided at both end portions in the vehicle width direction of the battery module 11. A flexible printed circuit board 21, which will be described later, is connected to the connector 14. A bus bar (not shown) is welded to both end portions of the battery module 11 in the vehicle width direction.

The length MW of the battery module 11 in the vehicle-width direction is, for example, 350 mm-600 mm, the length ML in the front-rear direction is, for example, 150 mm-250 mm, and the height MH in the up-down direction is, for example, 80 mm-110 mm.

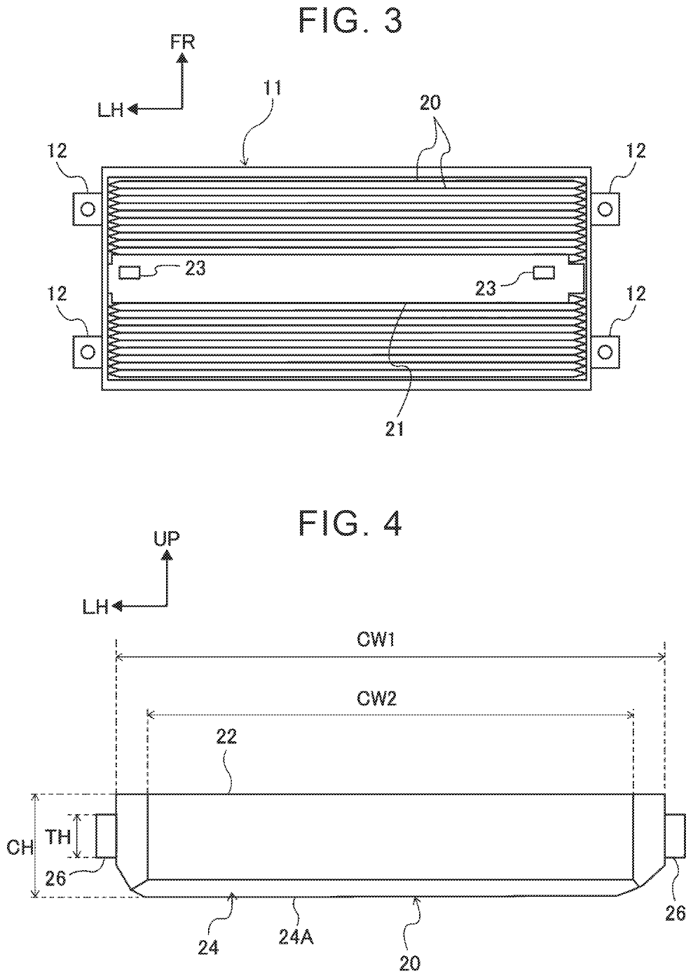

As shown in FIG. 3, a plurality of battery cells 20 are accommodated in the battery module 11 so as to be arranged in the thickness direction in the front-rear direction. In the present embodiment, as an example, 24 battery cells 20 are arranged in the thickness direction in the front-rear direction and are bonded to each other.

A flexible printed circuit (FPC) board 21) is disposed on the upper side of the battery cell 20 and on the center side thereof. The flexible printed circuit board 21 is formed in a band shape having a vehicle width direction as a longitudinal direction, and thermistors 23 are provided at both end portions of the flexible printed circuit board 21. The thermistor 23 is not adhered to the battery cell 20 and is pressed toward the battery cell 20 by the upper lid of the battery module 11.

One or a plurality of cushioning materials (not shown) are accommodated in the battery module 11. The cushioning material is, for example, an elastically deformable thin plate-shaped member, and is disposed between the adjacent battery cells 20 with the arrangement direction of the battery cells 20 as the thickness direction. In the present embodiment, as an example, cushioning materials are disposed at both end portions in the longitudinal direction of the battery module 11 and at a central portion in the longitudinal direction, respectively.

As shown in FIG. 4, the battery cell 20 is formed in a substantially rectangular plate shape, and an electrode body (not shown) is accommodated therein. The electrode body is formed by laminating an electrode (a negative electrode and a positive electrode) and a separator disposed between the electrodes, and is sealed with a laminate film 22 as an exterior body.

As the electrode, for example, one in which a layer containing an electrode active material is formed on one surface or both surfaces of a current collector is used. As the separator, for example, a microporous film formed of a resin such as polyethylene is used. The laminate film 22 is a laminate having a metal layer containing a metal such as aluminum and a heat seal layer.

In the present embodiment, as an example, the embossed sheet-like laminate film 22 is folded and a heat seal layer at a peripheral portion thereof is bonded to form a housing portion of the electrode body. Note that the laminate film 22 can adopt both a single-cup embossed structure in which embossing is performed at one place and a double-cup embossed structure in which embossing is performed at two places. In FIG. 4, a single-cup embossing configuration of the drawing depth 8 mm-10 mm degree is shown.

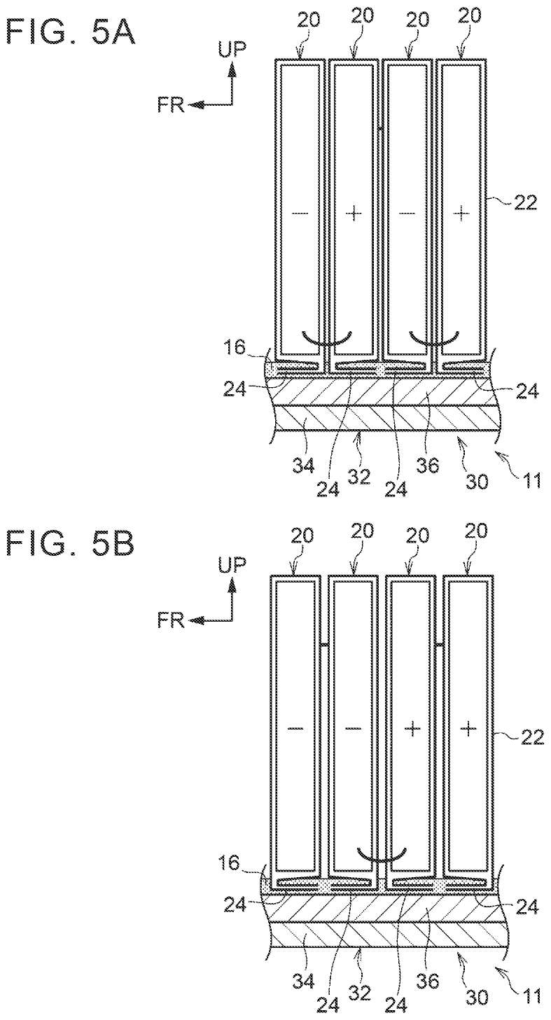

Further, the lower ends of the peripheral edge portions at both longitudinal end portions of the battery cell 20 shown in FIG. 4 are bent, and the peripheral edge portion 24 at the lower end portion of the battery cell 20 is also bent forward or backward as shown in FIGS. 5A and 5B. Note that the metallic layers are exposed from the lower end surface (front end surface) 24A of the peripheral edge portion 24 at the lower end portion.

Terminals (tabs) 26 are provided at both ends in the longitudinal direction of the battery cell 20. In the present embodiment, as an example, each terminal 26 is provided at a substantially central portion in the vertical direction of the battery cell 20, but each terminal 26 is not limited to this position, and may be provided at a position offset upward or downward from the substantially central portion in the vertical direction. Each of the terminals 26 is joined to a bus bar (not shown) by laser welding or the like.

The vehicle-width-direction length CW1 of the battery cells 20 is, for example, 530 mm-600 mm, 600 mm-700 mm, 700 mm-800 mm, 800-900 mm, 1000 mm or more. The length CW2 of the area in which the electrode assembly is accommodated is, for example, 500 mm-520 mm, 600 mm-700 mm, 700 mm-800 mm, 800-900 mm, 1000 mm or more.

The height CH of the battery cell 20 is, for example, 80 mm-110 mm, 110 mm-140 mm. The thickness of the battery cell 20 is 5.0 mm-7.0 mm, 7.0 mm-9.0 mm, 9.0 mm-11.0 mm, and the height TH of the terminal 26 is 40 mm-50 mm, 50 mm-60 mm, 60 mm-70 mm.

Next, the internal structure of the battery module 11 having the above-described configuration will be described in more detail.

### First Embodiment

First, a first embodiment will be described. As shown in FIG. 5A, at least the bottom wall 32 of the case 30 of the battery module 11 has a double structure, and has an outer wall 34 and an inner wall 36 having a predetermined thickness. The upper surface of the inner wall 36 is filled with a potting material 16 as a heat conductive member to a predetermined height.

That is, the plurality of battery cells 20 are accommodated in the case 30 in a state in which the peripheral edge portion 24 at the lower end portion thereof is folded toward the front side or the rear side. The potting material 16 is filled to a height such that at least the entire folded peripheral edge portion 24 is immersed. Therefore, the metal layer exposed from the peripheral edge portion 24 of each battery cell 20 comes into contact with the potting material 16. As a result, heat inside each battery cell 20 is dissipated from the metal layer to the outside via the potting material 16.

Incidentally, the respective terminals 26 in the four battery cells 20 shown in FIG. 5A (see FIG. 4), for example, the front side of the paper in order from the front side is a negative pole, positive pole, negative pole, the positive pole. That is, from the front side, the back side of the paper is the positive pole, the negative pole, the positive pole, and the negative pole.

In the four battery cells 20, for example, the peripheral edge portion 24 is bent toward the front side, the rear side, the front side, and the rear side in this order from the front side. Further, although not shown, in the plurality of battery cells 20 accommodated in the case 30, the thickness of the metal layer constituting the laminate film 22 is formed to be thicker on the central portion side in the stacking direction than on both end portions side in the stacking direction.

Next, the operation of the battery module 11 according to the first embodiment configured as described above will be described.

As shown in FIG. 5A, the plurality of battery cells 20 are accommodated in the case 30 while being stacked in the thickness direction. The metal layer is exposed from the peripheral edge portions 24 of the plurality of battery cells 20. The potting material 16 is filled in the case 30 and is provided at a predetermined height on the upper surface of the inner wall 36 of the bottom wall 32. The metal layer is in contact with the potting material 16.

Therefore, the metal layer constituting the laminate film 22 can function as a heat dissipation material to the potting material 16, and heat from the inside of each battery cell 20 can be efficiently dissipated. That is, the potting material 16 in direct contact with the metal layer can sufficiently ensure heat dissipation from the inside to the outside of each battery cell 20 (cooling efficiency can be improved).

In addition, the thickness of the metal layer of each battery cell 20 accommodated in the case 30 is thicker at the center portion side in the stacking direction of each battery cell 20 than at both end portions in the stacking direction. Here, it is known that in a stacked body in which a plurality of battery cells 20 are stacked, the temperature tends to increase toward the central portion side in the stacking direction, and it is known that the thicker the thickness of the metal layer, the higher the thermal conductivity. Therefore, it is possible to enhance the heat dissipation on the central portion side in the stacking direction where the temperature is likely to increase, and it is possible to ensure the heat dissipation from the inside to the outside of each battery cell 20 housed in the case 30 efficiently (in a well-balanced manner) in the stacking direction.

### Modification

The folding direction of the peripheral edge portion 24 in the respective battery cells 20 is not limited to the folding direction shown in FIG. 5A, and may be, for example, the folding direction shown in FIG. 5B. In other words, the terminals 26 (see FIG. 4) of the four battery cells 20 shown in FIG. 5B have negative poles, negative poles, positive poles, and positive poles on the front side of the paper in order from the front side. Each terminal 26, in order from the front side, the back side of the paper is positive, positive, negative, and negative poles.

In the four battery cells 20, the peripheral edge portion 24 is bent toward the rear side, the front side, the rear side, and the front side in this order from the front side. Therefore, in this case, even if the metal layers exposed from the peripheral edge portion 24 of the battery cell 20 face each other in the front-rear direction (stacking direction), the metal layers have the same potential. Therefore, even if the metal layers come into contact with each other, the risk caused thereby can be reduced.

### Second Embodiment

Next, a second embodiment will be described. Note that parts equivalent to those of the first embodiment are denoted by the same reference numerals, and detailed description thereof will be omitted as appropriate.

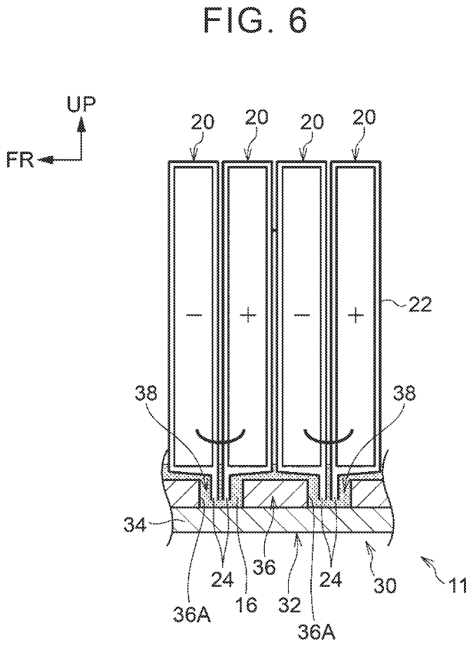

As shown in FIG. 6, in the second embodiment, a recessed portion 38 (groove portion) having a rectangular shape in plan view and extending in the longitudinal direction (vehicle width direction) is formed in the inner wall 36 of the bottom wall 32 of the case 30. The peripheral edge portion 24 of each battery cell 20 accommodated in the case 30 is inserted into the recessed portion 38 without being bent. Only these points are differences between the first embodiment and the second embodiment.

Incidentally, the recessed portion 38 shown in the drawing is constituted by a rectangular through-hole 36A in plan view formed in the inner wall 36 and the upper surface of the outer wall 34, but the present disclosure is not limited thereto, the recessed portion 38 may be configured to be formed at a predetermined depth on the upper surface of the inner wall 36. The inside of the recessed portion 38 is also necessarily filled with potting material 16. Therefore, the metal layer exposed from each peripheral edge portion 24 is configured to be in contact with the potting material 16 inside each recessed portion 38.

Further, the respective peripheral edge portions 24 of the two adjacent battery cells 20 are accommodated in the respective recessed portions 38. The lower end surface 24A (see FIG. 4) of each peripheral edge portion 24 accommodated in each recessed portion 38 is located on the same plane. That is, in the process of manufacturing the battery cells 20, the tips of the peripheral edge portions 24 of the battery cells 20 are cut together, so that the lengths (heights) of the peripheral edge portions 24 accommodated in the respective recessed portions 38 are aligned.

In addition, in the four battery cells 20 shown in FIG. 6, the terminals 26 (see FIG. 4) have negative poles, positive poles, negative poles, and positive poles in the front side of the drawing in order from the front side, as in the case of those shown in FIG. 5A. Each terminal 26, in order from the front side, the back side of the paper is positive, negative, positive, and negative poles. The terminals 26 are not limited thereto, and may be similar to those shown in FIG. 5B.

Next, the operation of the battery module 11 according to the second embodiment configured as described above will be described. The description of the operation common to the first embodiment will be omitted as appropriate.

As shown in FIG. 6, the inner wall 36 of the bottom wall 32 of the case 30 is formed with a plurality of recessed portions 38 capable of accommodating the peripheral edge portion 24 of each battery cell 20 and the potting material 16. The metal layer exposed from the peripheral edge portion 24 of each battery cell 20 is in contact with the potting material 16 inside the recessed portion 38. Therefore, the heat dissipation from the inside to the outside of each battery cell 20 can be sufficiently secured, and the position of each battery cell 20 accommodated in the case 30 can be fixed, and the posture of each battery cell 20 can be stabilized.

Moreover, the peripheral edge portions 24 of the two adjacent battery cells 20 are accommodated in the respective recessed portions 38. Therefore, the volume efficiency of each battery cell 20 with respect to the case 30 can be increased as compared with a configuration in which the peripheral edge portions 24 of each battery cell 20 are accommodated one by one for each recessed portion 38. The size of the battery module 11 can be made compact.

Further, the lower end surface 24A of the peripheral edge portions 24 accommodated in the respective recessed portions 38 are located on the same plane, and the lengths (heights) of the peripheral edge portions 24 accommodated in the respective recessed portions 38 are aligned in the respective battery cells 20. Therefore, the volume efficiency of each battery cell 20 with respect to the case 30 can be increased, and the posture of each battery cell 20 can be further stabilized.

As described above, the battery module 11 according to the present embodiment has been described based on the drawings, but the battery module 11 according to the present embodiment is not limited to the illustrated one, and can be appropriately changed in design without departing from the gist of the present disclosure.

For example, the metallic layers in the peripheral portion 28 of the laminate film 22 are not limited to being exposed from the end face 28A thereof, and may be exposed from other portions in the peripheral portion 28. In addition, the case 30 may not have a double structure. In this case, in the second embodiment, for example, the thickness of the outer wall 34 of the bottom wall 32 may be formed to be large, and the recessed portion 38 having a predetermined depth may be formed on the upper surface of the outer wall 34.

The type and size of the electrode body are not particularly limited, and are selected according to the size and use of the battery cell 20. The number of electrodes and separators included in the electrode assembly is not particularly limited, and is selected according to the size and use of the battery cell 20. Further, the vehicle 100 is not limited to battery electric vehicle. The vehicle 100 may be, for example, engine-mounted hybrid electric vehicle (HV) or plug-in hybrid electric vehicle (PHEV).

What is claimed is:

1. A battery module comprising:
a plurality of battery cells each including a laminate film including a metal layer and a heat seal layer, housing an electrode body, and obtained by joining portions of the heat seal layer at a peripheral edge;
a case in which the battery cells are housed while being stacked in a thickness direction; and
a heat conductive member provided on an inner wall of the case in contact with the metal layer exposed from the peripheral edge and configured to dissipate heat from the battery cell.

2. The battery module according to claim 1, wherein:
the inner wall of the case includes a plurality of recesses each configured to house the peripheral edge and the heat conductive member; and
the metal layer exposed from the peripheral edge is in contact with the heat conductive member inside the recess.

3. The battery module according to claim 2, wherein the peripheral edges of two of the battery cells that are adjacent to each other are housed in each of the recesses.

4. The battery module according to claim 3, wherein distal end surfaces of the peripheral edges housed in the recess are positioned on the same plane.

5. The battery module according to claim 1, wherein a thickness of the metal layer of the battery cell housed in the case is larger near a center in a stacking direction than near both ends in the stacking direction.
